(19) United States
(12) Patent Application Publication
(10) Pub. No.: US 2014/0321897 A1
(43) Pub. Date: Oct. 30, 2014

(54) IMAGE FORMING APPARATUS

(71) Applicant: CANON KABUSHIKI KAISHA, Tokyo (JP)

(72) Inventors: Atsushi Ogata, Mishima-shi (JP); Ichiro Yasumaru, Mishima-shi (JP); Kazushi Ino, Suntou-gun (JP); Hiroshi Kato, Odawara-shi (JP); Daisuke Kaneko, Suntou-gun (JP); Tomoyuki Iwakoshi, Suntou-gun (JP)

(73) Assignee: CANON KABUSHIKI KAISHA, Tokyo (JP)

(21) Appl. No.: 14/253,079

(22) Filed: Apr. 15, 2014

(30) Foreign Application Priority Data
Apr. 25, 2013 (JP) 2013-092115

(51) Int. Cl. G03G 15/00

(52) U.S. Cl. CPC G03G 15/602
USPC 399/373

(57) ABSTRACT

An image forming apparatus includes a document separation and feed portion separating and feeding a document, a document discharge roller pair discharging the document, and a sheet discharge roller pair discharging a sheet. The document separation and feed portion or the document discharge roller pair is disposed so as to overlap with the sheet discharge roller pair in a vertical direction.

### BACKGROUND OF THE INVENTION

1. Field of the Invention

The present invention relates to an image forming apparatus capable of reading an image of a document and of forming an image on a sheet.

2. Description of the Related Art

Hitherto, there is known an image forming apparatus including an image reading apparatus having an auto document feeder (ADF) capable of skimming a document as an image forming apparatus capable of realizing both reading an image of a document and forming the image on a sheet.

As such an image forming apparatus, Japanese Patent Application Laid-open No. 2007-159022 proposes an image forming apparatus configured such that a document feed tray and a document discharge tray are overlapped at an upper part of a body of the image forming apparatus and an image of a document is read during when the document moves a U-shaped conveying path connecting the document feed tray and the document discharge tray.

However, because the image forming apparatus described in Japanese Patent Application Laid-open No. 2007-159022 disposes the document feed tray and the document discharge tray at the upper part of the body of the image forming apparatus, the apparatus has such problems that a height of the whole apparatus increases and visibility of a sheet discharged on a sheet discharge tray drops.

### SUMMARY OF THE INVENTION

According to an aspect of the present invention, an image forming apparatus includes a sheet feed portion configured to feed a sheet, an image forming portion configured to form an image on the sheet, a sheet discharge roller pair configured to discharge the sheet on which the image has been formed by the image forming portion, a sheet stacking portion on which the sheet discharged by the sheet discharge roller pair is stacked, a feed document stacking portion on which a document whose image is to be read is stacked, a document feed portion configured to feed the document stacked on the feed document stacking portion while separating one by one, an image reading portion configured to read an image of the document fed from the document feed portion, a document discharge roller pair configured to discharge the document whose image has been read by the image reading portion, and a discharged document stacking portion on which the document discharged by the document discharge roller pair is stacked, wherein the document feed portion and the document discharge roller pair being disposed such that their horizontal positions are differentiated from the sheet discharge roller pair, and the document feed portion or the document discharge roller pair is disposed so as to overlap with the sheet discharge roller pair in a vertical direction.

Further features of the present invention will become apparent from the following description of exemplary embodiments with reference to the attached drawings.

### BRIEF DESCRIPTION OF THE DRAWINGS

FIG. 1 is a schematic section view showing a printer of a first embodiment of the present invention.

FIG. 2A is a schematic section view illustrating an image forming operation of the printer of the first embodiment in feeding a sheet.

FIG. 2B is a schematic section view illustrating the image forming operation of the printer of the first embodiment in reversing and conveying the sheet.

FIG. 3A is a schematic section view illustrating the image forming operation of the printer of the first embodiment in conveying the sheet through a common conveying path.

FIG. 3B is a schematic section view illustrating the image forming operation of the printer of the first embodiment in conveying the sheet through a U-turn conveying path.

FIG. 4A is a schematic section view illustrating an image reading operation of the printer of the first embodiment in conveying a document through the common conveying path.

FIG. 4B is a schematic section view illustrating the image reading operation of the printer of the first embodiment in conveying a document through the U-turn conveying path.

FIG. 5A is a schematic section view illustrating the image reading operation of the printer of the first embodiment in switching back and conveying a document through the common conveying path.

FIG. 5B is a schematic section view illustrating the image reading operation of the printer of the first embodiment in conveying a document through a document discharge path.

FIG. 6 is a schematic section view illustrating an upper part of the printer of the first embodiment.

FIG. 7A is a schematic section view illustrating an other configuration of a document feed portion provided with a separation pad.

FIG. 7B is a schematic section view illustrating a still other configuration of the document feed portion in which separation rollers are disposed under a document feed roller.

FIG. 7C is a schematic section view illustrating a different configuration of the document feed portion in which separation rollers are disposed above the document feed roller.

FIG. 8 is a schematic section view illustrating a printer of a second embodiment.

FIG. 9A is a schematic section view illustrating an image reading operation of the printer of the second embodiment in conveying a document through the document conveying path.

FIG. 9B is a schematic section view illustrating an image reading operation of the printer of the second embodiment in conveying a document through the document discharge path.

FIG. 10 is a schematic section view illustrating an upper part of the printer of the second embodiment.

FIG. 11 is a schematic section view illustrating a printer of a third embodiment.

FIG. 12A is a schematic section view illustrating an upper part of the printer of a comparative example or a modified embodiment in which the respective roller pairs are arrayed in a vertical direction.

FIG. 12B is a schematic section view illustrating an upper part of the printer of a comparative example or a modified embodiment in which the respective roller pairs are arrayed in a horizontal direction.

### DESCRIPTION OF THE EMBODIMENTS

An image forming apparatus of embodiments of the present invention will be described with reference to the drawings. The image forming apparatus of the embodiments of the invention includes an image reading apparatus capable of reading image information of a document, such as a copier, a printer, a facsimile, and a multi-function printer. The image forming apparatus will be described by assuming an electro-photographic laser beam printer (referred to simply as a “printer” hereinafter) in the following embodiments.

### First Embodiment

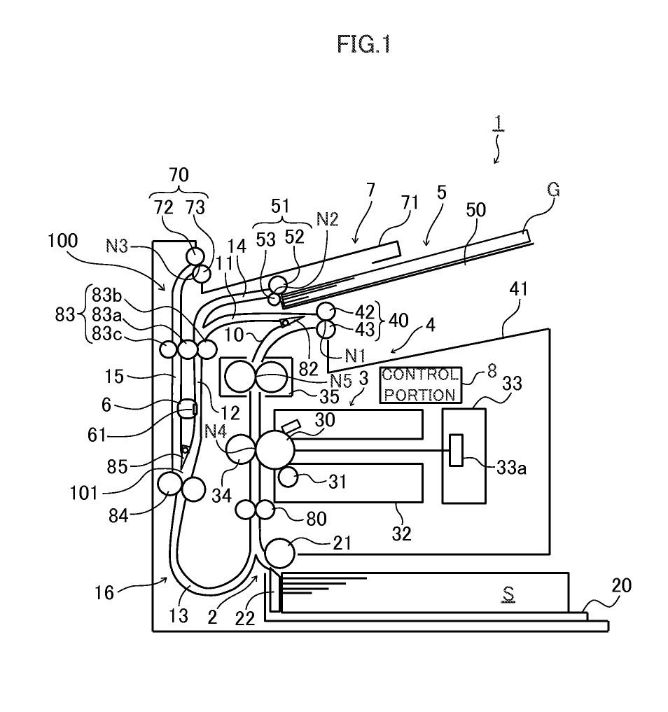

The printer 1 of a first embodiment of the invention will be described below with reference to FIG. 1 through FIG. 7C. At first, an overall schematic configuration of the printer 1 of the first embodiment will be described with reference to FIG. 1.

As shown in FIG. 1, the printer 1 includes a sheet feed portion 2 located at a lower part of the printer 1, an image forming portion 3 located above the sheet feed portion 2, and a sheet discharge portion 4 located above the image forming portion 3. The printer 1 also includes a document feed portion 5 located above the sheet discharge portion 4, an image reading portion 6 located at an inner side part of the printer 1, a document discharge portion 7 located above the document feed portion 5, and a control portion 8.

Still further, the printer 1 includes a sheet conveying path (first conveying path) 10 provided between the sheet feed portion 2 and the sheet discharge portion 4, and a duplex conveying path (second conveying path) 16 connecting a downstream and an upstream in a sheet conveying direction of the sheet conveying path 10. More specifically, the sheet conveying path 10 forms the conveying path between the sheet feed portion 2 and a sheet discharge roller pair 40 described later and the image forming portion 3 is provided on a way of the conveying path. Still further, the duplex conveying path connect the upstream and downstream in the sheet conveying direction of the image forming portion 3 of the sheet conveying path 10 in a manner of bypassing the image forming portion 3 and includes a reverse conveying path 11 connected to the downstream in the sheet conveying direction of the sheet conveying path 10, a common conveying path 12 connected to a downstream end of the reverse conveying path 11, and a U-turn conveying path 13 connecting a downstream end of the common conveying path 12 with the upstream in the conveying direction of the sheet conveying path 10. The printer 1 also includes a document feed path 14 connecting the document feed portion 5 with an upstream end of the common conveying path 12 and a document discharge path 15 connecting the downstream end of the common conveying path 12 with the document discharge portion 7. It is noted that in the present embodiment, a document conveying path 100 is formed by a document feed path connected with the document feed portion 5, a document discharge path 15 connected with the document discharge roller pair 70, and a common conveying path 12 serving as at least part of the duplex conveying path 16 and through which both of a sheet being formed with an image on its first surface by the image forming portion 3 and a document fed from the document feed portion 5 pass. The document conveying path then guides the document from the document feed path 14 to the document discharge path 15 through the common conveying path 12.

The sheet feed portion 2 includes a feed tray 20 stacking sheets S, a feed roller 21 feeding the sheets S on the feed tray 20, and a separation portion 22 separating the sheets S fed by the feed roller 21 one by one.

The image forming portion 3 includes a processing cartridge 32 constructed by integrating image forming processing portions such as a photoconductive drum 30, a developing sleeve 31, and others, and a exposure unit 33 configured to irradiate a laser beam to the photoconductive drum 30 based on image information. The image forming portion 3 also includes a transfer roller 34 configured to transfer a toner image formed on the photoconductive drum 30 to a sheet S and a fixing portion 35 configured to fix the toner image transferred to the sheet S.

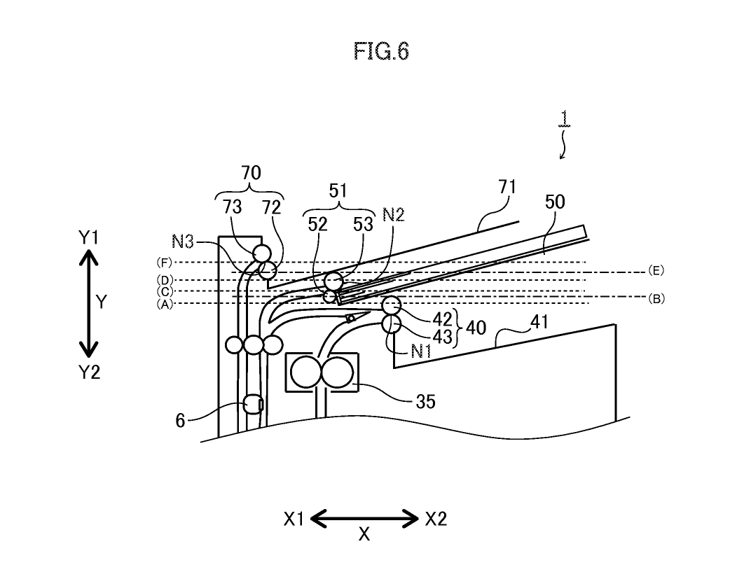

The sheet discharge portion 4 includes the sheet discharge roller pair 40 capable of conveying a sheet by rotating normally and reversely and a sheet discharge tray (sheet stacking portion) 41 on which the sheet S discharged out of the apparatus body by the sheet discharge roller pair 40 is stacked. The sheet discharge roller pair 40 is composed of an upper discharge roller 42 disposed above and a lower discharge roller 43 disposed under the upper discharge roller 42 and is capable of discharging the sheet S by nipping the sheet S by a nip portion N1 between the upper discharge roller 42 and the lower discharge roller 43. The sheet discharge roller pair 40 is disposed such that the nip portion N1 is located above the image forming portion 3. The sheet discharge tray 41 extends while inclining upward in a direction distant from a document separation and feed portion 51 (in a direction X2 in FIG. 6).

The document feed portion 5 includes a document feed tray (feed document stacking portion) 50 on which a document G whose image is to be read is stacked and a document separation and feed portion (document feed portion) 51 feeding the documents G stacked on the document feed tray 50 by separating one by one. The document feed tray 50 extends above the sheet discharge tray 41 while inclining upward in a direction distant from the document separation and feed portion 51 (the X2 direction in FIG. 6). The document separation and feed portion 51 includes a document feed roller 52 disposed above and a separation roller 53 in pressure contact with the document feed roller 52 from underneath, and feeds the documents G in separation one by one by nipping the document G by the nip portion N2 between the document feed roller 52 and the separation roller 53. Specifically, the separation roller 53 is rotatably supported by a separation roller shaft not shown through an intermediary of a torque limiter not shown, and is in pressure contact with the document feed roller 52 as the separation roller shaft is biased toward the document feed roller 52 by a spring not shown. It is noted that the separation roller 53 may be configured such the sheet S is separated by reversely driving the separation roller shaft instead of rotatably supporting the separation roller 53 by the separation roller shaft through the torque limiter. An arrangement of the document separation and feed portion 51 with respect to the sheet discharge roller pair 40 described above will be also detailed later.

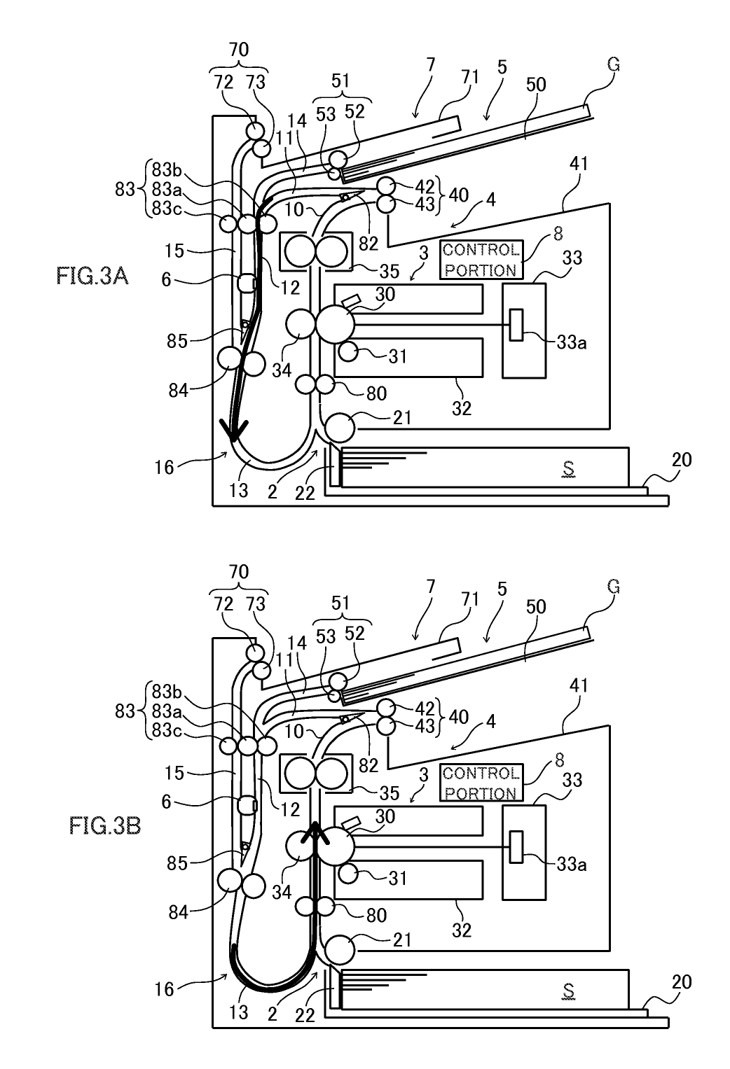

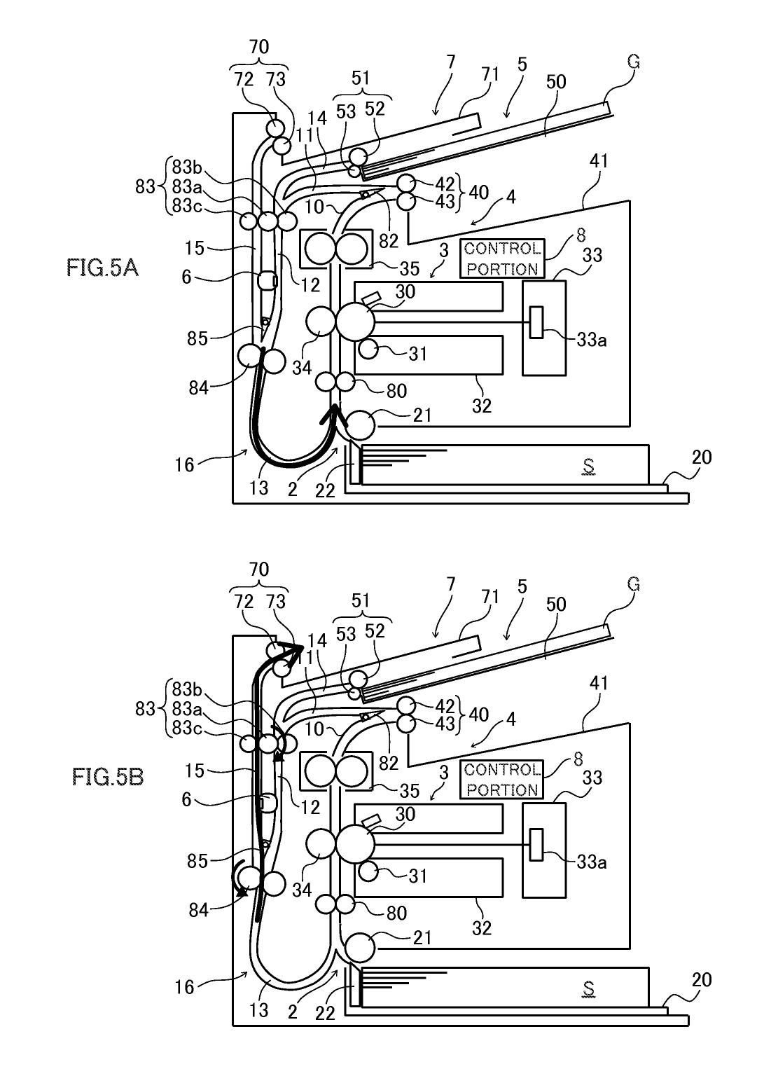

The image reading portion 6 configured to read an image of a document fed by the document feed portion 5 is provided under the nip portion N1 of the sheet discharge roller pair 40 and between the common conveying path 12 and the document discharge path 15 and is configured to be able to rotate and move a first read position (first position, see a position in FIG. 3A) for reading an image of a document G passing through the common conveying path 12 and a second reading position (second position, see a position in FIG. 5B) for reading an image of a document G passing through the document discharge path 15 by 180 degrees. In other words, the image reading portion 6 is provided between the document discharge path 15 and the common conveying path 12. That is, the document discharge path 15 is provided in parallel with a part of the common conveying path 12 and is formed such that one end thereof merges (connects) with the common conveying path 12 at a merge portion (connection portion) 101. Then, the image reading portion 6 is configured to be able to change its position to a first position where a sensor surface 61 thereof reading an image faces the common conveying path 12 side and reads an image of a first surface of the document conveyed through the common conveying path 12 and to a second position where the sensor surface 61 faces the document discharge path 15 side and reads an image formed on a second surface of the document conveyed to the document discharge path 15 by being switched back at the merge portion 101. It is noted that a different arrangement of providing separate image reading portions to be able to read first and second faces of documents G may be adopted, beside the arrangement of rotating the image reading portion 6.

The document discharge portion 7 includes a document discharge roller pair 70 configured to discharge the document G whose image has been read to out of the apparatus and a document discharge tray (discharged document stacking portion) 71 on which the document G discharged out of the apparatus is stacked. The document discharge roller pair 70 is composed of an upper discharge roller 72 disposed above and a lower discharge roller 73 disposed under the upper discharge roller 72, and conveys the document G by nipping by a nip portion N3 between the upper discharge roller 72 and the lower discharge roller 73. The document discharge tray 71 is provided above the document feed tray 50. Similarly to the document separation and feed portion 51, the document discharge roller pair 70 is disposed such that the nip portion N3 thereof is located above the nip portion N1 of the sheet discharge roller pair 40. The document discharge tray 71 extends while inclining upward in the direction distant from the document separation and feed portion 51 (the X2 direction in FIG. 6). It is noted that an arrangement of the document discharge roller pair 70 with respect to the document separation and feed portion 51 described above will be detailed later.

The sheet conveying path 10 extends upward so as to be able to guide the sheet S fed from the sheet feed portion 2 to the sheet discharge tray 41 by passing through a transfer nip N4 and a fixing nip N5 of the image forming portion 3. The sheet discharge roller pair 40 described above is provided at a downstream end in the sheet conveying direction of the sheet conveying path 10. The reverse conveying path 11 extends substantially in the horizontal direction toward a side opposite from the sheet discharge tray 41, and a first switching member 82 configured to guide the sheet S is provided at a branch point of the sheet conveying path 10 and the reverse conveying path 11. The common conveying path 12 extends downward and is provided with a duplex conveying triple roller 83 at upstream in the sheet conveying direction thereof. The triple roller 83 has nip portions formed on both sides of a driving roller 83a by rollers 83b and 83c in pressure contact with the roller 83a with a predetermined pressure.

The U-turn conveying path 13 extends downward, makes a U-turn at a lower end part, and is connected to the sheet conveying path 10 between the sheet feed portion 2 and the image forming portion 3. The U-turn conveying path 13 is provided with a duplex conveying roller pair (document reverse conveying portion) 84 capable of rotating normally and reversely at upstream in the conveying direction thereof. A second switching member 85 is provided at a branch portion of the U-turn conveying path 13, the common conveying path 12 and the document discharge path 15. The document discharge path 15 extends upward substantially in parallel with the common conveying path 12 and is provided with the document discharge roller pair 70 described above at a downstream end in the sheet conveying direction thereof.

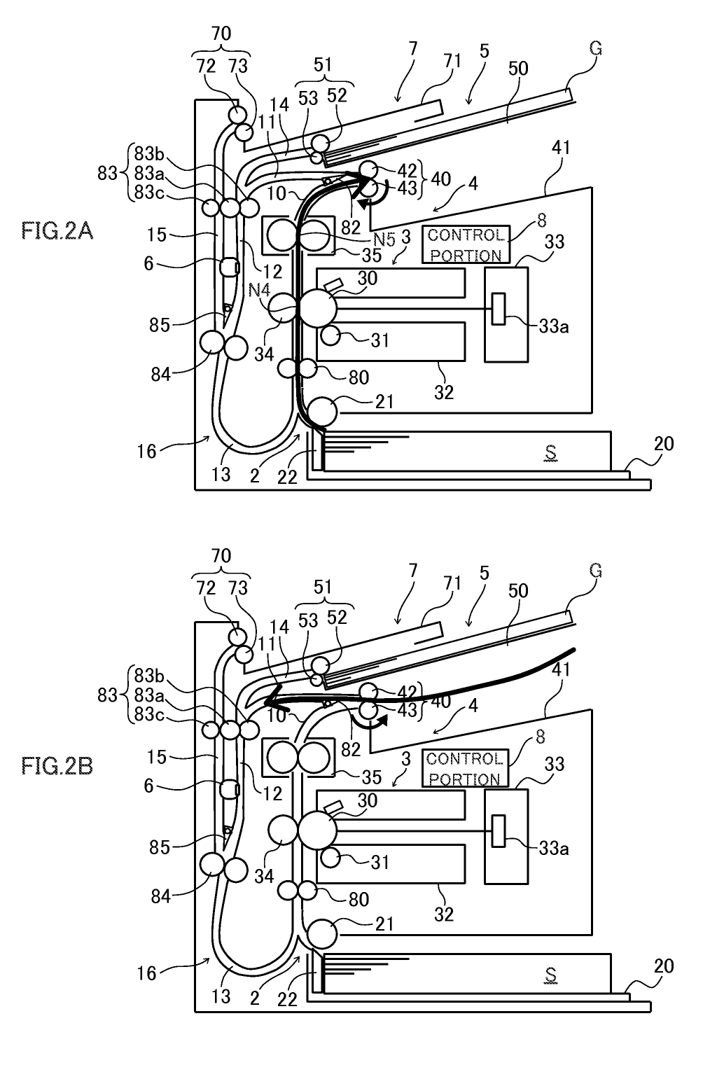

Next, an image forming operation (simplex and duplex printings) of the printer 1 constructed as described above will be described with reference to FIGS. 2 and 3.

By receiving a print signal, the exposure unit 33 irradiates a laser beam from a light emitting portion 33a provided therein based on image information to the photoconductive drum 30 whose surface is charged to form an electrostatic latent image on the photoconductive drum 30. Then, the electrostatic latent image is developed by toner supplied from the developing sleeve 31 and is visualized as a toner image. In parallel with the toner image forming operation, a sheet S is sent one by one out of the sheet feed portion 2 and is conveyed to the transfer nip N4 at a predetermined timing by the conveying roller pair 80. When the sheet S arrives at the transfer nip N4 as shown in FIG. 2A, the toner image is transferred to a first surface of the sheet S by an applied bias and pressure and is fixed by heat and pressure applied at the fixing nip N5 downstream the transfer nip N4. The sheet S on which the toner image has been fixed is then discharged out of the apparatus by the sheet discharge roller pair 40 and is stacked on the sheet discharge tray 41. Thus, the image forming operation of the simplex printing ends.

Meanwhile, in a case of forming images on both sides of the sheet S (duplex printing), the sheet discharge roller pair 40 is rotated reversely and the first switching member 82 is turned to switch a conveying direction of the sheet S as a rear end of sheet S passes through the branch portion of the sheet conveying path 10 and the reverse conveying path 11. By being switched back by the sheet discharge roller pair 40, the sheet S on which the image has been formed on the first surface thereof is guided substantially horizontally through the reverse conveying path 11 from the rear end until then as a head as shown in FIG. 2B and enters the common conveying path 12.

The sheet S entering the common conveying path 12 is conveyed downward along the common conveying path 12 by the driving roller 83a and the roller 83b as shown in FIG. 3A and enters the U-turn conveying path 13. The sheet S that entering the U-turn conveying path 13 is turned around by a driving roller 83a and a roller 83b not shown along the U-turn conveying path 13 and enters the sheet conveying path 10 again as shown in FIG. 3B. Thereby, the sheet S is guided to the conveying roller pair 80 again in a condition in which the front and back (first and second) surfaces of the sheet S are reversed, and an image is formed on a second surface by a similar operation performed in forming the image on the first surface. The sheet S on which the images have been formed on the both (first and second) surfaces is then discharged out of the apparatus by the sheet discharge roller pair 40 and is stacked on the sheet discharge portion 4. Thus, the image forming operation of the duplex printing ends.

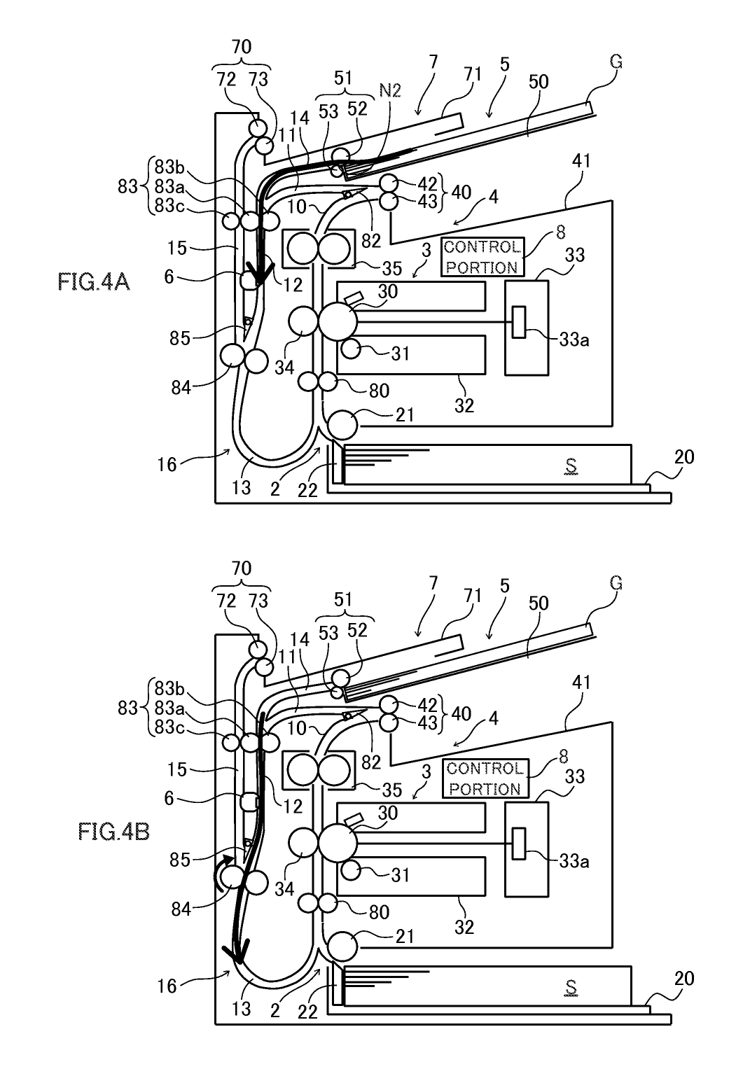

Next, an operation of reading an image of the document G by the printer 1 constructed as described above (simplex and duplex reading) will be explained with reference to FIGS. 4 and 5.

In the case of reading the image of the document G, the document feed roller 52 is rotated to nip the document G at the nip portion N2 between the document feed roller 52 and the separation roller 53 and to feed the document G to the document feed path 14. At this time, if a second document G or after is fed following the first document G, the torque limiter applies a torque in a direction opposite from a direction of rotation following the document feed roller 52 to the separation roller 53 to prevent the second document G and after from being fed following the first document G. When only the first document G is fed, the torque limiter permits the separation roller 53 to be driven following the document feed roller 52 to feed the document G.

The document G fed to the document feed path 14 is conveyed toward a downstream in a document G feed direction (downward) along the common conveying path 12 by the driving roller 83a and the roller 83b as shown in FIG. 14A. At this time, the image reading portion 6 moves to the first reading position where the image reading portion 6 reads the image of the document G passing through the common conveying path 12. That is, an image of a first surface is read as the document G passes through the common conveying path 12. Image information thus read is stored in a memory as image information of the first surface of the document G.

The document G that has passed through the image reading portion 6 is guided to the U-turn conveying path 13 by the second switching member 85 and is conveyed to the U-turn conveying path 13 by the duplex conveying roller pair 84 as shown in FIG. 4B. When a detection sensor detects that a rear end of the document G has passed through the second switching member 85 as shown in FIG. 5A, the duplex conveying roller pair 84 is rotated reversely and the second switching member 85 is turned to switch the conveying direction of the document G to the document discharge path 15. Thereby, the document G is switched back at the merge portion (connection portion) 101 toward the document discharge path 15.

In response to the switch-back of the document G, the image reading portion 6 is moved from the first reading position to the second reading position to read an image of a second surface of the document G as the document G passes through the document discharge path 15 as shown in FIG. 5B. Image information thus read is stored in the memory as image information of the second surface of the document G.

The document G that has passed through the image reading portion 6 is conveyed upward along the document discharge path 15 by the driving roller 83a and the roller 83c, is discharged out of the apparatus by the document discharge roller pair 70, and is stacked on the document discharge tray 71. It is noted that in response to the end of reading of the document G, the image reading portion 6 turns by 180 degrees to move again to the first reading position to be ready to read an image of a document G passing through the common conveying path 12. It is also possible to control such that the image reading portion 6 does not move in a case where a user selects a single surface reading operation arbitrarily.

It is then possible to execute the image forming operation described above based on the image information stored in the memory in a case where the user selects a copy mode, and to transmit the image information to an external personal computer or the like as electronic data when the copy mode is not selected.

Next, the arrangement of the sheet discharge roller pair 40, the document separation and feed portion 51 and the document discharge roller pair 70 located at the upper part of the printer 1 will be described with reference to FIG. 6.

As shown in FIG. 6, the document separation and feed portion is provided on one side (X1 side) in a width direction (horizontal direction) X shown in FIG. 6 more than the sheet discharge roller pair 40, and the document discharge roller pair 70 is provided further on the one side (X1 side) more than the document separation and feed portion 51. In other words, the document separation and feed portion 51 is offset with respect to the sheet discharge roller pair 40 to the one side in the width direction X (on the side opposite from the sheet discharge tray 41) and the document discharge roller pair 70 is offset with respect to the document separation and feed portion 51 to the one side in the width direction X.

The document separation and feed portion 51 is also provided such that the nip portion N2 (level C in FIG. 6) is located at a level higher than the level of the nip portion N1 of the sheet discharge roller pair 40 (Y1 side in FIG. 6) and overlaps partly with the sheet discharge roller pair 40 in the vertical direction Y shown in FIG. 6. Specifically, the document separation and feed portion 51 is provided such that a lowermost part (A) of the separation roller 53 is located at a level lower (to the Y2 side) than an uppermost part (B) of the upper discharge roller 42 of the sheet discharge roller pair 40. The document separation and feed portion 51 is also provided such that the nip portion N2 (C) is located at a level higher (the Y1 side) than the uppermost part (B) of the upper discharge roller 42.

In the same manner, the document discharge roller pair 70 is provided such that the nip portion N3 (F) is located at a level higher (the Y1 side) than the nip portion N2 (C) of the document separation and feed portion 51 and overlaps partly with the document separation and feed portion 51 in the vertical direction Y shown in FIG. 6. Specifically, the document discharge roller pair 70 is provided such that a lowermost part (D) of the lower discharge roller 72 is located at a level lower (the Y2 side) than an uppermost part (E) of the document feed roller 52 of the document separation and feed portion 51 and the nip portion N3 (F) is located at a level higher (the Y1 side) than the uppermost part (E) of the document feed roller 52.

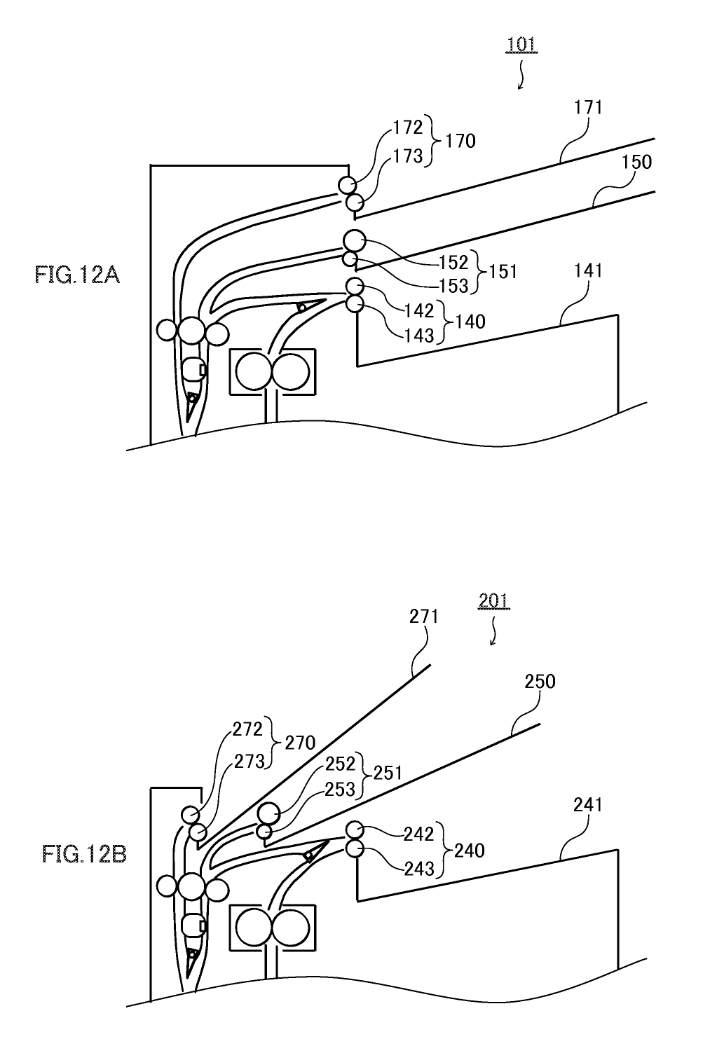

It is possible to improve visibility and handleability such as settability and accessability of the document G and the sheet S while suppressing a height of the printer 1 by disposing the sheet discharge roller pair 40, the document separation and feed portion 51 and the document discharge roller pair 70 as described above. For instance, if the respective roller pairs are arrayed in the vertical direction as shown in a comparative example, i.e., a printer 101, shown in FIG. 12A, a height of the printer increases and visibility of sheets and documents stacked on the each tray drops. However, it is possible to lower the height of the printer 1 without dropping the visibility and handleability of the documents G and sheets S by disposing the respective roller pairs in offset in the width direction X and partly in overlap with each other in the vertical direction Y as described above in the printer 1. It is noted that the arrangement may be altered such that only the sheet discharge roller pair 40 and the document separation and feed portion 51 overlap each other in the vertical direction or only the document separation and feed portion 51 and the document discharge roller pair 70 overlap each other in the vertical direction. This arrangement also makes it possible to suppress the height of the printer 1.

The respective roller pairs may be also arrayed in the width direction such that their levels are substantially equalized as shown in a printer 201 in FIG. 12B. In this case, however, an arrangement angle of each tray increases as compared to the configuration shown in FIG. 1. Because the positions of the nip portions N1 through N3 of the respective roller pairs are shifted in the vertical direction Y in the printer 1 shown in FIG. 1, it is not necessary to increase an arrangement angle of each tray. Accordingly, the visibility and handleability of the printer 1 shown in FIG. 1 will drop less as compared to the printer 201 shown in FIG. 12B.

As described above, the document separation and feed portion 51 and the document discharge roller pair 70 are disposed in offset in the width direction X above the sheet discharge roller pair 40 in the printer 1 of the present embodiment. Therefore this configuration makes it possible to improve the setability on the document feed tray 50 without lowering the visibility of the sheet discharge tray 41 and the document discharge tray 71. Still further, because the parts of the sheet discharge roller pair 40, the document separation and feed portion 51, and the document discharge roller pair 70 overlap with each other in the vertical direction Y, it is possible to suppress an increase of the height and to downsize the printer 1. The closer to the X1 side, the higher the nip position of the sheet discharge roller pair 40, the document separation and feed portion 51 or the document discharge roller pair is. Therefore, this arrangement makes it possible to fully suppress the arrangement angle of each tray, and in conjunction with that the lower the position of the document discharge tray 71, the document feed tray 50, and the sheet discharge tray 41, the further the end position thereof is located in the X2 direction in this order, to improve the visibility of the sheets and documents stacked on each tray and to suppress the height of the apparatus.

### Second Embodiment

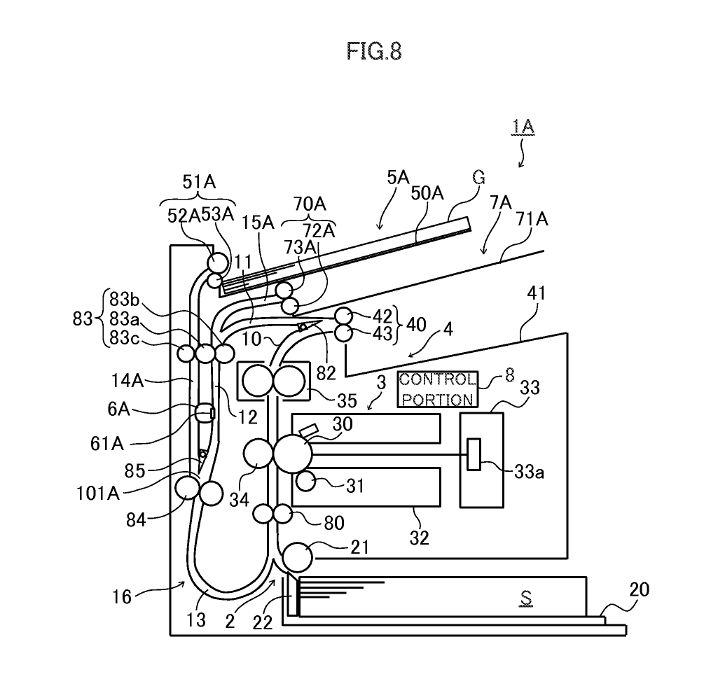

Next, a printer 1A of a second embodiment of the present invention will be described with reference to FIGS. 8 through 10. The printer 1A of the second embodiment is different in an arrangement of the document feed portion and the document discharge portion from that of the first embodiment. Therefore, the difference from the first embodiment, i.e., the arrangement of the document feed portion and the document discharge portion, will be mainly described in the second embodiment, and the same or corresponding configurations with those of the first embodiment will be denoted by the same reference numerals and an explanation thereof will be omitted here.

As shown in FIG. 8, the printer 1A includes the sheet feed portion 2, the image forming portion 3, the sheet discharge portion 4, a document feed portion 5A located above a document discharge portion 7A, the image reading portion 6, and a document discharge portion 7A located above the sheet discharge portion 4 and below the document feed portion 5A. The printer 1A also includes the control portion 8, the sheet conveying path (first conveying path) 10 and the duplex conveying path (second conveying path) 16. The duplex conveying path 16 includes the reverse conveying path 11, the common conveying path 12, and the U-turn conveying path 13. The printer 1A further includes a document feed path 14A connecting the document feed portion 5 with a downstream end of the common conveying path 12, and a document discharge path 15A connecting an upstream end of the common conveying path 12 with the document discharge portion 7.

The document feed portion 5A includes a document feed tray 50A stacking a document G and a document separation and feed portion 51A feeding the document G stacked on the document feed tray 50A while separating one by one. The document feed tray 50A is provided above the document discharge portion 7A. The document separation and feed portion 51A includes a document feed roller 52A disposed above and a separation roller 53A in pressure contact with the document feed roller 52A from underneath, and feeds the document G by nipping, while separating one by one, by a nip portion between the document feed roller 52A and the separation roller 53A.

The document discharge portion 7A includes a document discharge roller pair 70A discharging the document G whose image has been read out of the apparatus and a document discharge tray 71A stacking the document G discharged out of the apparatus. The document discharge roller pair 70A is composed of an upper discharge roller 72A disposed above and a lower discharge roller 73A disposed under the upper discharge roller 72A, and conveys the document G by nipping by a nip portion between the upper discharge roller 72A and the lower discharge roller 73A. The document feed tray 50A is provided above the document discharge tray 71A. The document feed tray 50A and the document discharge tray 71A are disposed at positions shifted in the width direction from each other.

The document feed path 14A is provided in parallel with a part of the common conveying path 12 and is formed such that one end thereof merges with the common conveying path 12 at a merge portion, and the image reading portion 6A is disposed between the common conveying path 12 and the document feed path 14A. Then the image reading portion 6 is configured to be able to change a position thereof to a first read position (first position) where a sensor surface 61A thereof reading an image faces the document feed path 14A side and reads an image formed on a first surface of the document conveyed through the document feed path 14A and to a second position where the sensor surface 61A faces the common conveying path 12 side and reads an image formed on a second surface of the document conveyed to the common conveying path 12 by being switched back at the merge portion 101A.

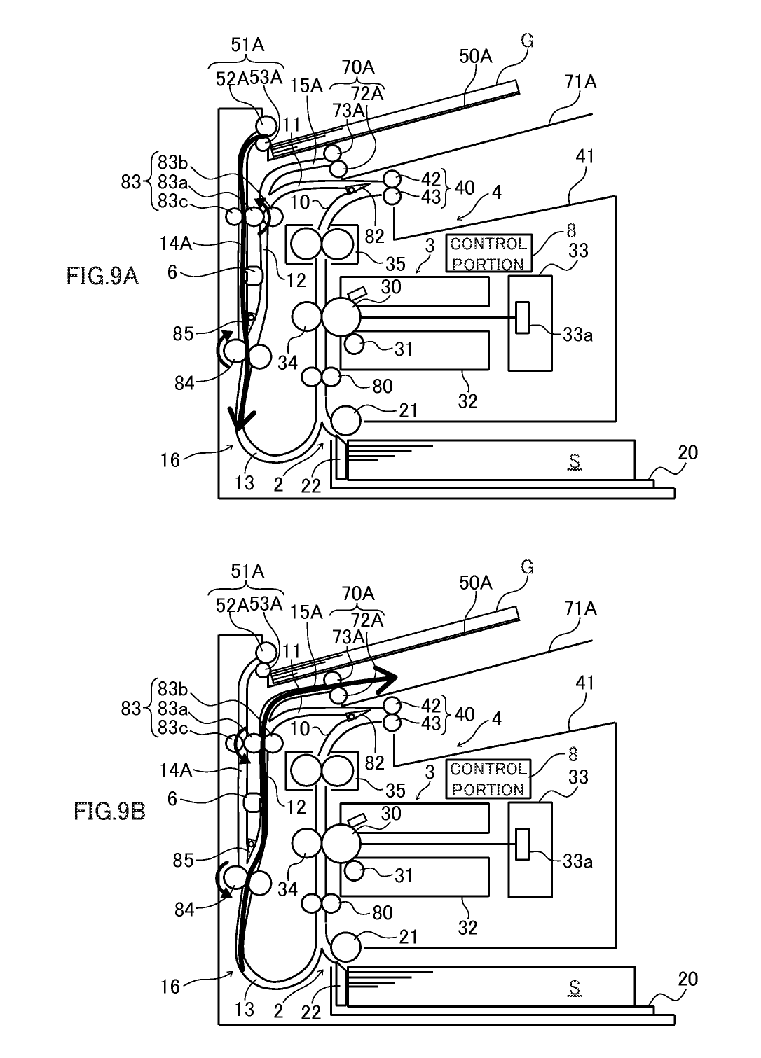

Next, operations of reading images of the document G (simplex and duplex reading) by the printer 1A constructed as described above will be described with reference to FIGS. 9A and 9B. As shown in FIG. 9A, the document G sent out to the document feed path 14A by the document separation and feed portion 51 is conveyed to the downstream (downward) of the feed direction by the driving roller 83a and the roller 83c, and an image of a first surface of the document G is read by the image reading portion 6 located at the second reading position. Image information thus read is stored in the memory, and the document G is guided to the U-turn conveying path 13 by the second switching member 85 and conveyed to the U-turn conveying path 13 by the duplex conveying roller pair 84. Then, as the rear end of the document G passes through the second switching member 85, the document G is switched back to the common conveying path 12 and an image on a second surface of the document G is read when the document G passes through the common conveying path 12. It is noted that the image reading portion 6 is rotated to the first reading position at this time, and the read image information is stored in the memory. The document G that has passed through the image reading portion 6 is conveyed along the document discharge path 15A by the driving roller 83a and the roller 83b, is discharged out of the apparatus by the document discharge roller pair 70A, and is stacked on the document discharge tray 71A as shown in FIG. 9B.

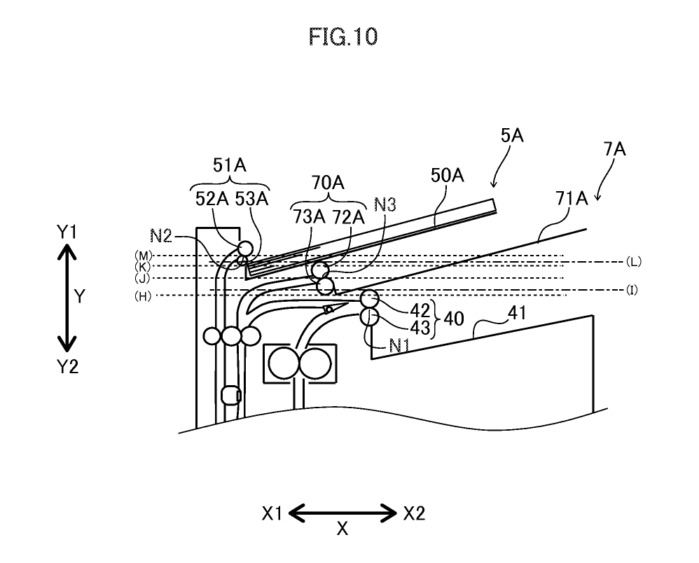

Next, the arrangement of the sheet discharge roller pair 40, the document separation and feed portion 51A and the document discharge roller pair 70A located at the upper part of the printer 1A will be described with reference to FIG. 10. As shown in FIG. 10, the document discharge roller pair 70A is provided on one side (X1 side) in the width direction X shown in FIG. 10 more than the sheet discharge roller pair 40, and the document separation and feed portion 51A is provided further on the one side (X1 side) more than the document separation and feed portion 51A.

The document discharge roller pair 70A is also provided such that the nip portion N3 (level J in FIG. 10) is located at a level higher than the level of the nip portion N1 of the sheet discharge roller pair 40 (Y1 side in FIG. 10) and overlaps partly with the sheet discharge roller pair 40 in the vertical direction Y shown in FIG. 10. Specifically, the document discharge roller pair 70A is provided such that a lowermost part (H) of the lower discharge roller 72A is located at a level lower (to the Y2 side) than an uppermost part (I) of the upper discharge roller 42 of the sheet discharge roller pair 40. The document discharge roller pair 70A is also provided such that the nip portion N3 (J) is located at a level higher (the Y1 side) than the uppermost part (I) of the sheet discharge roller pair 40.

In the same manner, the document separation and feed portion 51A is provided such that the nip portion N2 (M) is located at a level higher (the Y1 side) than the nip portion N3 (J) of the document discharge roller pair 70A and overlaps partly with the document discharge roller pair 70A in the vertical direction Y shown in FIG. 10. Specifically, the document separation and feed portion 51A is provided such that a lowermost part (K) of the separation roller 53A is located at a level lower (the Y2 side) than an uppermost part (L) of the upper discharge roller 72A of the document discharge roller pair 70A and the nip portion N3 (M) is located at a level higher (the Y1 side) than the uppermost part (L) of the upper discharge roller 72A.

It is possible to improve visibility and handleability such as settability and accessability of the document G and the sheet S while suppressing a height of the printer 1A by disposing the sheet discharge roller pair 40, the document separation and feed portion 51A and the document discharge roller pair 70A as described above. It is noted that the arrangement may be made such that only the sheet discharge roller pair 40 and the document discharge roller pair 70 overlap each other in the vertical direction or such that only the document discharge roller pair 70A and the document separation and feed portion 51A overlap each other in the vertical direction. These arrangements also make it possible to suppress the height of the printer 1A.

### Third Embodiment

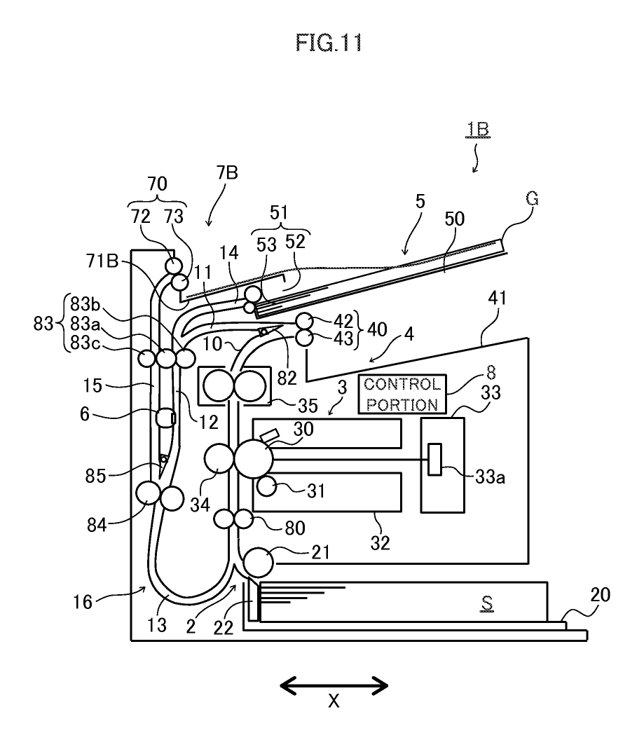

Next, a printer 1B of a third embodiment of the present invention will be described with reference to FIG. 11. The printer 1B of the third embodiment is different from the first embodiment in size of the document discharge tray. Therefore, the difference from the first embodiment, i.e., the document discharge tray, will be mainly described in the third embodiment, and the same or corresponding configurations with those of the first embodiment will be denoted by the same reference numerals and an explanation thereof will be omitted here.

As shown in FIG. 11, the printer 1B includes the sheet feed portion 2, the image forming portion 3, the sheet discharge portion 4, the document feed portion 5, the image reading portion 6, a document discharge portion 7B located above the document feed portion 5, and the control portion 8. The printer 1B also includes the sheet conveying path 10 and the duplex conveying path 16. The duplex conveying path 16 includes the reverse conveying path 11, the common conveying path 12, and the U-turn conveying path 13. The printer 1B further includes the document feed path 14 and the document discharge path 15.

The document discharge portion 7B includes the document discharge roller pair 70 and a document discharge tray (discharged document stacking portion) 71B stacking the document G discharged out of the apparatus. A length in the width direction X shown in FIG. 11 of the document discharge tray 71B is shorter than the level of the document discharge tray 71 of the first embodiment. Thereby, a front edge portion in a discharge direction of the document G discharged on the document discharge tray 71B is stacked on the document feed tray 50 or a document G to be fed stacked on the document feed tray 50.

It is possible to lower the height of the printer 1B and to downsize the printer 1B by shortening the length in the width direction X of the document discharge tray 71B located at an uppermost part of the printer 1B as described above. Still further, because a space above the document feed tray 50 is widened by shortening the widthwise length of the document discharge tray 71B, it is possible to improve settability and visibility of the document G. In addition, even if the respective roller pairs are arranged in the vertical direction as shown in FIG. 12B, it is possible to suppress the drop of the visibility and handleability by using the document discharge tray as shown in FIG. 11 that supports the part of the discharged document closer to the document discharge roller pair 70.

While the embodiments of the present invention have been described above, the invention is not limited to the embodiments described above. Still further, the advantageous effects described in the embodiments of the invention are merely what the most preferable effects brought about from the invention are enumerated, and the effects of the invention are not limited to what described in the embodiments of the invention.

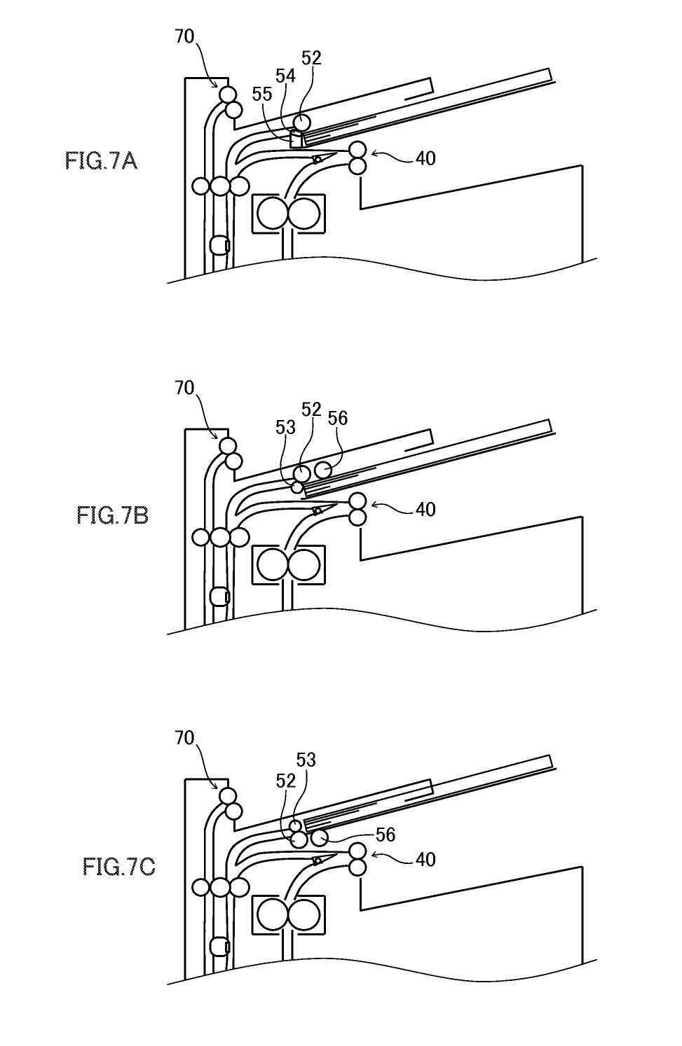

For instance, while the invention has been described by using the document separation and feed portion 51 composed of the document feed roller 52 and the separation roller 53 in the embodiments, the invention is not limited to that. As shown in FIG. 7A, the document separation and feed portion may use a separation portion composed a flat separation pad 54 and a hold member 55 holding the separation pad, instead of the separation roller. The hold member 55 is biased toward the document feed roller 52 by a spring not shown that generates a force of pressing the separation pad 54 against the document feed roller 52. It is noted that even in the case where the separation portion is used, the advantageous effects of the invention may be achieved as long as a lowermost part of the holding member 55 is located at a level higher than the level of the nip portion of the sheet discharge roller pair 40 and overlaps with the sheet discharge roller pair 40 in the vertical direction. In the separation portion shown in FIG. 7A, the lowermost part of the separation pad 54 is located at a level lower than the uppermost part of the sheet discharge roller pair 40, and the uppermost part of the document feed roller 52 is located at a level higher than the lowermost part of the document discharge roller pair 70.

Still further, as shown in FIG. 7B, the document feed portion may be composed of a pickup roller 56 performing contact and separation motions against a document, the document feed roller 52 and the separation roller 53. In the document feed portion shown in FIG. 7B, an uppermost part of the pickup roller 56 is located at a level higher than the level of the lowermost part of the document discharge roller pair 70, and the uppermost part of the document feed roller 52 is located at a level higher than the level of the lowermost part of the document discharge roller pair 70. Still further, the lowermost part of the separation roller 53 is located under the uppermost part of the sheet discharge roller pair 40. It is noted that the arrangement using the separation portion instead of the separation roller 53 may be adopted also in this case.

Still further, the document feed portion may be arranged such that documents are fed from a lowest document as shown in FIG. 7C instead of feeding from an uppermost document stacked on the document feed tray. The document feed portion shown in FIG. 7C includes the pickup roller 56, the document feed roller 52 and the separation roller 53, and a lowermost part of the pickup roller 56 is located at a level lower than the uppermost part of the sheet discharge roller pair 40. Still further, the lowermost part of the document feed roller 52 is located at a level lower than the uppermost part of the sheet discharge roller pair 40, and the uppermost part of the separation roller 53 is located at a level higher than the level of the lowermost part of the sheet discharge roller pair 40. It is noted that the arrangement using the separation portion instead of the separation roller 53 may be adopted also in this case.

While the present invention has been described with reference to the exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-092115, filed on Apr. 25, 2013, which is hereby incorporated by reference herein in its entirety.

What is claimed is:

1. An image forming apparatus comprising:
a sheet feed portion configured to feed a sheet;
an image forming portion configured to form an image on the sheet;
a sheet discharge roller pair configured to discharge the sheet on which the image has been formed by the image forming portion;
a sheet stacking portion on which the sheet discharged by the sheet discharge roller pair is stacked;
a feed document stacking portion on which a document whose image is to be read is stacked;
a document feed portion configured to feed the document stacked on the feed document stacking portion while separating one by one;
an image reading portion configured to read an image of the document fed from the document feed portion;
a document discharge roller pair configured to discharge the document whose image has been read by the image reading portion; and
a discharged document stacking portion on which the document discharged by the document discharge roller pair is stacked;
wherein the document feed portion and the document discharge roller pair being disposed such that their horizontal positions are differentiated from the sheet discharge roller pair, and
the document feed portion or the document discharge roller pair is disposed so as to overlap with the sheet discharge roller pair in a vertical direction.

2. The image forming apparatus according to claim 1, wherein the document feed portion and the document discharge roller pair are disposed such that their horizontal positions are differentiated from each other and such that the document discharge roller pair overlaps with the document feed portion in the vertical direction.

3. The image forming apparatus according to claim 2, wherein the sheet discharge roller pair has a nip portion for nipping and conveying a sheet, the nip portion being disposed at a level higher than the level of the image forming portion,
the document feed portion and the document discharge roller pair are disposed at levels higher than the level of the nip portion of the sheet discharge roller pair, and
the image reading portion is disposed at a level lower than the level of the nip portion of the sheet discharge roller pair.

4. The image forming apparatus according to claim 1, wherein the document feed portion and the document discharge roller pair are disposed on a side opposite from the sheet stacking portion with respect to the sheet discharge roller pair in a horizontal direction.

5. The image forming apparatus according to claim 3, wherein the document feed portion and the document discharge roller pair are disposed on a side opposite from the sheet stacking portion with respect to the sheet discharge roller pair in a horizontal direction.

6. The image forming apparatus according to claim 5, wherein the document feed portion and the document discharge roller pair have nip portions, respectively, for nipping and conveying a document and are vertically overlapped with each other without vertically overlapping their nip portions, and
the sheet stacking portion, the feed document stacking portion and the discharged document stacking portion extend respectively by being inclined upward toward a first direction separating horizontally from the sheet discharge roller pair, the document feed portion and the document discharge roller pair.

7. The image forming apparatus according to claim 1, further comprising:
a first conveying path forming a conveying path from the sheet feed portion to the sheet discharge roller pair, the image forming portion being disposed on a way of the first conveying path;
a second conveying path connecting an upstream side and a downstream side in a sheet conveying direction of the first conveying path divided by the image forming portion in a manner of bypassing the image forming portion; and
a document conveying path including a document feed path connected with the document feed portion, a document discharge path connected with the document discharge roller pair, and a common conveying path serving as at least part of the second conveying path and through which both a sheet being formed with an image on its first surface by the image forming portion and a document fed from the document feed portion pass, the document conveying path guiding the document from the document feed path to the document discharge path through the common conveying path,
wherein the image reading portion is disposed so as to be able to read an image of the document passing through the common conveying path.

8. An image forming apparatus according to claim 7, wherein the nip portion of the document discharge roller pair is disposed above the nip portion of the document feed portion,
the document feed portion is disposed between the sheet discharge roller pair and the document discharge roller pair in the horizontal direction, and
the feed document stacking portion is formed such that a horizontal end position thereof is located at a position distant in the first direction more than an end position of the discharged document stacking portion.

9. The image forming apparatus according to claim 8, wherein the document discharge path is provided in parallel with the common conveying path and is formed such that one end thereof connects with the common conveying path at a connection portion, and
the image reading portion is disposed between the common conveying path and the document discharge path provided so as to face with each other and is configured to be able to change a position thereof to a first position where a sensor surface thereof reading an image faces the common conveying path side and reads an image of a first surface of the document conveyed through the common conveying path and to a second position where the sensor surface faces the document discharge path side and reads an image formed on a second surface of the document conveyed to the document discharge path by being switched back at the connection portion.

10. An image forming apparatus according to claim 6, wherein the nip portion of the document feed portion is disposed above the nip portion of the document discharge roller pair,
the document discharge roller pair is disposed between the sheet discharge roller pair and the document feed portion in the horizontal direction, and
the discharged document stacking portion is formed such that a horizontal end position thereof is located at a position distant in the first direction more than an end position of the feed document stacking portion.

11. The image forming apparatus according to claim 10, wherein the document feed path is provided in parallel with the common conveying path and is formed such that one end thereof connects with the common conveying path at a connection portion, and
the image reading portion is disposed between the common conveying path and the document feed path provided so as to face with each other and is configured to be able to change a position thereof to a first position where a sensor surface thereof reading an image faces the document feed path side and reads an image formed on a first surface of the document conveyed through the document feed path and to a second position where the sensor surface faces the common conveying path side and reads an image formed on a second surface of the document conveyed to the common conveying path by being switched back at the connection portion.

12. The image forming apparatus according to claim 1, wherein the document feed portion includes a document feed roller configured to feed a document and a separation roller in pressure contact with the document feed roller and configured to separate documents one by one, and
the separation roller and the sheet discharge roller pair are overlapped with each other in the vertical direction.

13. The image forming apparatus according to claim 1, wherein the document feed portion includes a document feed roller configured to feed a document and a separation portion having a separation pad in pressure contact with the document feed roller and configured to separate documents one by one and a hold member holding the separation pad, and
the separation roller and the sheet discharge roller pair are overlapped with each other in the vertical direction.

14. An image forming apparatus according to claim 1, wherein the nip portion of the document discharge roller pair is disposed above the nip portion of the document feed portion,
the document feed portion is disposed between the sheet discharge roller pair and the document discharge roller pair in the horizontal direction, and
the document feed portion and the sheet discharge roller pair are overlapped with the sheet discharge roller pair in the vertical direction.

15. An image forming apparatus according to claim 1, wherein the nip portion of the document feed portion is disposed above the nip portion of the document discharge roller pair,
the document discharge roller pair is disposed between the sheet discharge roller pair and the document feed portion in the horizontal direction, and
document discharge roller pair and the sheet discharge roller pair are overlapped with each other in the vertical direction.

16. The image forming apparatus according to claim 1, further comprising:
a first conveying path guiding a sheet upward from the sheet feed portion to the sheet discharge roller pair, the image forming portion being disposed on a way of the first conveying path;
a second conveying path guiding the sheet downward on which the image has been formed on one surface thereof by the image forming portion to the first conveying path again; and
a document conveying path including a document feed path connected with the document feed portion, a document discharge path connected with the document discharge roller pair, and a common conveying path serving as at least part of the second conveying path and through which both a sheet being formed with an image on its first surface by the image forming portion and a document fed from the document feed portion pass, the document conveying path guiding the document from the document feed path to the document discharge path through the common conveying path.
